(19) United States
(12) Patent Application Publication
(10) Pub. No.: US 2025/0391089 A1
(43) Pub. Date: Dec. 25, 2025

(54) EFFECT PROCESSING METHOD AND APPARATUS, ELECTRONIC DEVICE, AND STORAGE MEDIUM

(71) Applicant: Beijing Zitiao Network Technology Co., Ltd., Haidian District, Beijing (CN)

(72) Inventors: Ruchong LUO, Beijing (CN); Jinyuan CAO, Beijing (CN)

(21) Appl. No.: 18/880,246

(22) PCT Filed: Jun. 20, 2023
(86) PCT No.: PCT/CN2023/101295

§ 371 Date: Dec. 30, 2024

(30) Foreign Application Priority Data
Jul. 22, 2022 (CN) 202210869590.6

(51) Int. Cl. G06T 15/00; G06T 19/20

(52) U.S. Cl. CPC G06T 15/005; G06T 19/20; G06T 2219/2012

(57) ABSTRACT

Embodiments of the present disclosure provide an effect processing method and apparatus, an electronic device, and a storage medium. The method includes: obtaining a screen image to be processed and determining a region to be processed that corresponds to the screen image to be processed, in response to an effect trigger operation for the screen image to be processed; determining a three-dimensional mask model corresponding to the region to be processed, and generating a region mask image corresponding to the region to be processed based on the three-dimensional mask model; and applying the region mask image to the region to be processed for the screen image to be processed to obtain a target effect image, and displaying the target effect image.

The present application claims priority to Chinese Patent Application No. 202210869590.6, filed with the China National Intellectual Property Administration on Jul. 22, 2022, which is incorporated herein by reference in its entirety.

### FIELD

Embodiments of the present disclosure relate to image processing technologies and, for example, to an effect processing method and apparatus, an electronic device, and a storage medium.

### BACKGROUND

With the continuous development of Internet technology and effect processing technology, effect can be added to videos or images based on the user needs.

### SUMMARY

The present disclosure provides an effect processing method and apparatus, an electronic device, and a storage medium.

According to a first aspect, an embodiment of the present disclosure provides an effect processing method. The method includes:
obtaining a screen image to be processed and determining a region to be processed that corresponds to the screen image to be processed, in response to an effect trigger operation for the screen image to be processed;
determining a three-dimensional mask model corresponding to the region to be processed, and generating a region mask image corresponding to the region to be processed based on the three-dimensional mask model; and
applying the region mask image to the region to be processed for the screen image to be processed to obtain a target effect image, and displaying the target effect image.

According to a second aspect, an embodiment of the present disclosure further provides an effect processing apparatus. The apparatus includes:
an image obtaining module configured to obtain a screen image to be processed and determine a region to be processed that corresponds to the screen image to be processed, in response to an effect trigger operation for the screen image to be processed;
a mask image generation module configured to determine a three-dimensional mask model corresponding to the region to be processed, and generate a region mask image corresponding to the region to be processed based on the three-dimensional mask model; and
an effect image display module configured to apply the region mask image to the region to be processed for the screen image to be processed to obtain a target effect image, and display the target effect image.

According to a third aspect, an embodiment of the present disclosure further provides an electronic device. The electronic device includes:
one or more processors; and
a storage apparatus configured to store one or more programs, where
the one or more programs, when executed by the one or more processors, cause the one or more processors to implement the effect processing method described in any one of the embodiments of the present disclosure.

According to a fourth aspect, an embodiment of the present disclosure further provides a storage medium containing computer-executable instructions, where the computer-executable instructions, when executed by a computer processor, are used to perform the effect processing method described in any one of the embodiments of the present disclosure.

### BRIEF DESCRIPTION OF THE DRAWINGS

Throughout the drawings, the same or similar reference numerals denote the same or similar elements. It should be understood that the accompanying drawings are schematic and that parts and elements are not necessarily drawn to scale.

FIG. 1 is a schematic flowchart of an effect processing method according to an embodiment of the present disclosure;

FIG. 2 is a schematic flowchart of another effect processing method according to an embodiment of the present disclosure;

FIG. 3 is a schematic flowchart of another effect processing method according to an embodiment of the present disclosure;

FIG. 4 is a schematic flowchart of another effect processing method according to an embodiment of the present disclosure;

FIG. 5 is a schematic diagram of an effect image obtained by processing using a related technology according to an embodiment of the present disclosure;

FIG. 6 is a schematic diagram of a target effect image obtained by processing on the basis of an effect processing method of an embodiment of the present disclosure according to an embodiment of the present disclosure;

FIG. 7 is a schematic diagram of a structure of an effect processing apparatus according to an embodiment of the present disclosure; and

FIG. 8 is a schematic diagram of a structure of an electronic device according to an embodiment of the present disclosure.

### DETAILED DESCRIPTION OF EMBODIMENTS

When an effect is added to a video or an image, pixels of the video or image that are displayed on a screen are usually processed. However, using this processing method, the effect obtained after the processing is overly planar and has poor adaptability to the processed part, which results in a poor effect of the effect and thus affects the visual experience of the user.

In view of the above situation, embodiments of the present disclosure disclose an effect processing method and apparatus, an electronic device, and a storage medium.

The embodiments of the present disclosure are described below with reference to the accompanying drawings. Although some embodiments of the present disclosure are shown in the accompanying drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and the embodiments of the present disclosure are only for exemplary purposes, and are not intended to limit the scope of protection of the present disclosure.

It should be understood that the various steps described in the method implementations of the present disclosure may be performed in different orders, and/or performed in parallel. Furthermore, additional steps may be included and/or the execution of the illustrated steps may be omitted in the method implementations. The scope of the present disclosure is not limited in this respect.

The term “include/comprise” used herein and the variations thereof are an open-ended inclusion, namely, “include/comprise but not limited to”. The term “based on” is “at least partially based on”. The term “an embodiment” means “at least one embodiment”. The term “another embodiment” means “at least one another embodiment”. The term “some embodiments” means “at least some embodiments”. Related definitions of the other terms will be given in the description below.

It should be noted that concepts such as “first” and “second” mentioned in the present disclosure are only used to distinguish different apparatuses, modules, or units, and are not used to limit the sequence of functions performed by these apparatuses, modules, or units or interdependence.

It should be noted that the modifiers “one” and “a plurality of” mentioned in the present disclosure are illustrative and not restrictive, and those skilled in the art should understand that unless the context clearly indicates otherwise, the modifiers should be understood as “one or more”.

The names of messages or information exchanged between a plurality of apparatuses in the implementations of the present disclosure are used for illustrative purposes only, and are not used to limit the scope of these messages or information.

It can be understood that before the use of the embodiments of the present disclosure, the user shall be informed of the type, range of use, use scenarios, etc., of personal information involved in the present disclosure in an appropriate manner in accordance with relevant laws and regulations, and the authorization of the user shall be obtained.

For example, in response to reception of an active request from a user, prompt information is sent to the user to clearly inform the user that a requested operation will require access to and use of personal information of the user. As such, the user is enabled to independently choose, based on prompt information, whether to provide the personal information to software or hardware, such as an electronic device, an application, a server, or a storage medium that performs the operations of the embodiments of the present disclosure.

As an optional but non-limiting implementation, in response to the reception of the active request from the user, the prompt information may be sent to the user in the form of, for example, a pop-up window, in which the prompt information may be presented in text. Furthermore, the pop-up window may also include a selection control for the user to choose whether to “agree” or “disagree” to provide the personal information to the electronic device.

It can be understood that the above process of notifying and obtaining user authorization is only illustrative and does not constitute a limitation on the implementations of the present disclosure, and other manners that satisfy the relevant laws and regulations may also be applied in the implementations of the present disclosure.

It can be understood that the data involved in the embodiments of the present disclosure (including, but not limited to, the data itself and the access to or use of the data) shall comply with the requirements of corresponding laws, regulations, and relevant provisions.

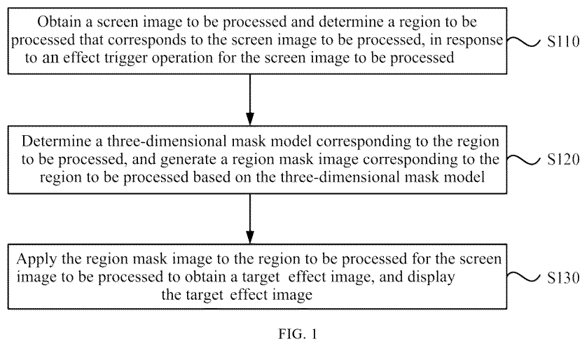

FIG. 1 is a schematic flowchart of an effect processing method according to an embodiment of the present disclosure. In this embodiment of the present disclosure, an effect may be added to a screen image to be processed and the added effect may be made to have three-dimensionality. The method may be performed by an effect processing apparatus. The apparatus may be implemented in the form of software and/or hardware, for example, by means of an electronic device, which may be a mobile terminal, a personal computer (PC) or a server, or the like.

As shown in FIG. 1, the method includes the following steps.

S110: Obtain a screen image to be processed and determine a region to be processed that corresponds to the screen image to be processed, in response to an effect trigger operation for the screen image to be processed.

The screen image to be processed may be an image displayed on a screen that is to be subjected to effect processing. The screen image to be processed may be an image obtained on the basis of photographing by a photographing apparatus, or may be an image determined by means of uploading, downloading, selecting, or the like.

The effect trigger operation may be an operation for triggering addition of an effect. It can be understood that before the response is made to an effect trigger operation for the screen image to be processed, the method further includes: receiving the effect trigger operation for the screen image to be processed. For example, receiving the effect trigger operation for the screen image to be processed may be receiving a trigger operation acting on a preset effect enabling control or an operation of detecting the presence of a subject that triggers the effect in the screen image to be processed, or receiving a voice instruction or a gesture instruction for enabling the effect, etc.

The region to be processed may be a region in the screen image to be processed to which the effect is to be added. For example, the region to be processed may be a region that is box-selected in the screen image to be processed, or it may also be a preset region around a point of action of a click operation by a user in the screen image to be processed after the click operation is received, for example, a region of a preset shape with the point of action as a center point, or a region surrounded by an outer contour of a subject where the point of action is located. Alternatively, after the effect trigger operation is received, a preset subject to which the effect is to be applied that corresponds to the effect trigger operation is determined, and the subject to which the effect is to be applied in the screen image to be processed is recognized, and the region to be processed is determined based on the recognized region. For example, the recognized region may be used as the region to be processed, or a region obtained by region expansion of the recognized region may be used as the region to be processed. The region expansion may be performed based on a preset expansion direction and expansion size, or by means of dilation of pixels, or the like. For example, a feature of the region to which the effect corresponding to the effect trigger operation is applied is a face-related feature. Accordingly, when the screen image to be processed is recognized, the recognized facial region may be used as the region to be processed, or a region containing a part or all of the facial region may be used as the region to be processed.

In response to the effect trigger operation, an image corresponding to the effect trigger operation is obtained as the screen image to be processed. Further, based on the received effect trigger operation, the region in the screen image to be processed that corresponds to the effect trigger operation is determined as the region to be processed that corresponds to the screen image to be processed.

S120: Determine a three-dimensional mask model corresponding to the region to be processed, and generate a region mask image corresponding to the region to be processed based on the three-dimensional mask model.

The three-dimensional mask model may be a pre-established three-dimensional model or a three-dimensional model established in real time based on the region to be processed. The region mask image may be understood as an image used to mask the region to be processed. In this embodiment of the present disclosure, the region mask image generated by the three-dimensional mask model can improve the three-dimensionality of the image of the region to be processed after effect processing is performed thereon.

For example, after the region to be processed is determined, a three-dimensional mask model matching the region to be processed is determined. Further, the three-dimensional mask model may be processed. Details of the three-dimensional mask model may be processed based on the image region to be processed, so that the three-dimensional mask model, after being processed, is adapted to the image of the region to be processed, and an image obtained after the processing is used as the region mask image corresponding to the region to be processed.

In an example, the three-dimensional mask model corresponding to the region to be processed may be determined using at least one of the following approaches.

Approach 1: Construct the three-dimensional mask model corresponding to the region to be processed based on image information contained in the region to be processed.

The image information may be a subject contained in the region to be processed as determined after analyzing the region to be processed, which may, for example, include a person, a plant, or a vehicle, or the like, or it may also be detailed information of the subject, for example, various parts contained in the subject, or the like, and may further include size information of the subject, or the like.

For example, the region to be processed is analyzed to determine the image information contained in the region to be processed. A three-dimensional mask model matching the region to be processed may be established based on the image information, so that the established three-dimensional mask model has a high adaptability to the region to be processed.

Approach 2: Determine a three-dimensional mask model matching the region to be processed from a pre-established three-dimensional mask model library based on image information contained in the region to be processed.

The three-dimensional mask model library includes at least one three-dimensional mask model.

For example, the correspondence between three-dimensional mask models and subject categories may be pre-established in the three-dimensional mask model library. The region to be processed is analyzed to determine the image information contained in the region to be processed. The image information may include subject information, or the like. Further, a subject category may be determined based on the subject information in the image to be processed, and a three-dimensional mask model corresponding to this subject category can be determined from the pre-established three-dimensional mask model library based on the subject category and used as the three-dimensional mask model matching the region to be processed. If there are a plurality of three-dimensional mask models that correspond to this subject category, any one of them may be used as the three-dimensional mask model matching the region to be processed, or the determined plurality of three-dimensional mask models may be provided to the user for selection by the user.

Approach 3: First determine a three-dimensional mask model matching the region to be processed from a pre-established three-dimensional mask model library based on image information contained in the region to be processed, and if it does not exist, construct a three-dimensional mask model corresponding to the region to be processed based on the image information contained in the region to be processed.

S130: Apply the region mask image to the region to be processed for the screen image to be processed to obtain a target effect image, and display the target effect image.

The target effect image may be understood as a screen image to be processed to which the effect has been added, that is, the screen image to be processed obtained after the region mask image is applied to the region to be processed. In other words, the target effect image is an image composed of the region mask image masking the region to be processed and the region other than the screen image to be processed.

The region mask image is applied to the region to be processed for the screen image to be processed, which means that the region mask image is displayed at the region to be processed for the screen image to be processed. For example, a pixel value of each pixel in the region to be processed for the screen image to be processed may be set to null, and the pixel value of each pixel in the region mask image may be correspondingly filled into each pixel in the screen image to be processed in which the pixel value has been set to null, thereby obtaining the target effect image. Alternatively, a layer containing the region mask image may be added on the screen image to be processed, where other parts of the layer than the region mask image are transparent. The layer is overlaid on the screen image to be processed, so that the part of the region mask image is overlaid on the region to be processed, thereby obtaining the target effect image. Alternatively, the pixel values of pixels in the region mask image may be merged with the pixel values of pixels in the region to be processed for the screen image to be processed, thereby obtaining the target effect image. Finally, the obtained target effect image is displayed so that the user can view the image to which the effect has been added.

In this embodiment of the present disclosure, by obtaining a screen image to be processed and determining a region to be processed that corresponds to the screen image to be processed, in response to an effect trigger operation for the screen image to be processed, a part of the screen image to be processed that is to be subjected to effect processing is determined, which supports effect processing of a part or all of the screen image to be processed. Further, by determining a three-dimensional mask model corresponding to the region to be processed, and generating a region mask image corresponding to the region to be processed based on the three-dimensional mask model, a region mask image with three-dimensionality is obtained, and by applying the region mask image to the region to be processed for the screen image to be processed to obtain a target effect image, and displaying the target effect image, it is possible to avoid the situations of a poor effect of the effect due to the effect being overly planar and of poor adaptability between the effect and the image, thereby enabling the processed region to be processed to have three-dimensionality and the target effect image to be more vivid, thus enriching the display effect of the image.

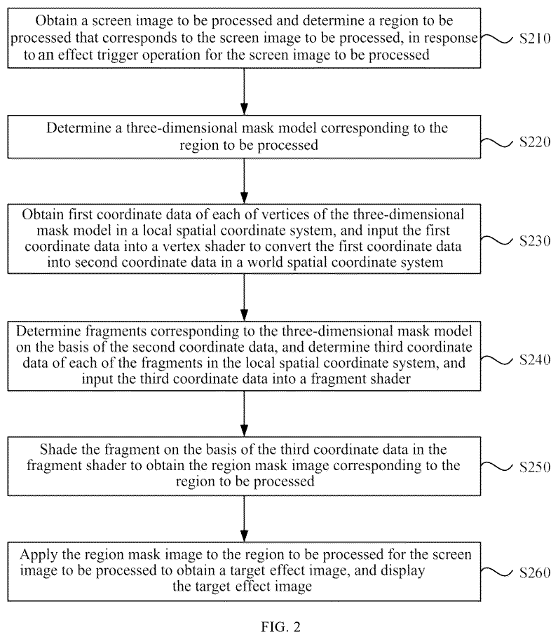

FIG. 2 is a schematic flowchart of another effect processing method according to an embodiment of the present disclosure. On the basis of the foregoing embodiments, reference may be made to the description of this embodiment for a method of determining the region mask image corresponding to the region to be processed. Explanations of the terms identical or corresponding to those in the above embodiments are not repeated herein.

As shown in FIG. 2, the method includes the following steps:

S210: Obtain a screen image to be processed and determine a region to be processed that corresponds to the screen image to be processed, in response to an effect trigger operation for the screen image to be processed.

S220: Determine a three-dimensional mask model corresponding to the region to be processed.

S230: Obtain first coordinate data of each of vertices of the three-dimensional mask model in a local spatial coordinate system, and input the first coordinate data into a vertex shader to convert the first coordinate data into second coordinate data in a world spatial coordinate system.

The local spatial coordinate system may be a local coordinate system corresponding to the three-dimensional mask model. The first coordinate data may be coordinate information of each of the vertices of the three-dimensional mask model in the local spatial coordinate system. It can be understood that the first coordinate data of each of the vertices of the three-dimensional mask model in the local spatial coordinate system may be coordinate information assigned to each of the vertices when the three-dimensional mask model is established. The vertex shader may be used to convert the first coordinate data of each of the vertices into the world spatial coordinate system. The second coordinate data may be the output result of the vertex shader, which represents coordinate information of each of the first coordinate data in the world spatial coordinate system.

For example, after the three-dimensional mask model is determined, the first coordinate data corresponding to each of the vertices in the three-dimensional mask model in the local spatial coordinate system may be obtained. The first coordinate data is input into the vertex shader. After calculation by the vertex shader, the first coordinate data may be converted into the world spatial coordinate system to obtain coordinate information corresponding to the first coordinate data, which is the second coordinate data.

S240: Determine fragments corresponding to the three-dimensional mask model on the basis of the second coordinate data, and determine third coordinate data of each of the fragments in the local spatial coordinate system, and input the third coordinate data into a fragment shader.

The fragment may be an image unit obtained by performing primitive assembly, rasterization processing, or the like on the three-dimensional mask model, which may be converted into pixel data. The third coordinate data may be coordinate information of each of the fragments in the local spatial coordinate system. The fragment shader may be used to shade the fragments.

For example, primitive assembly, rasterization processing, or the like are performed on the three-dimensional mask model based on the second coordinate data to obtain the fragments corresponding to the three-dimensional mask model. For each of the fragments, coordinate information of this fragment in the local spatial coordinate system is determined, which is the third coordinate data. After the third coordinate data is obtained, the third coordinate data is input into the fragment shader to perform shading processing on each of the fragments.

In an example, determining fragments corresponding to the three-dimensional mask model on the basis of the second coordinate data includes: performing primitive assembly on each of the vertices on the basis of the second coordinate data to obtain at least one first primitive corresponding to the three-dimensional mask model; processing the first primitive by a geometry shader to divide the first primitive into at least two second primitives; and performing rasterization processing on each of the second primitives to obtain the fragments corresponding to the three-dimensional mask model.

The first primitive may be a line or a face that is obtained by connecting the vertices together. For example, it may be a triangle, a quadrilateral or a hexagon, or the like. For example, primitive assembly is performed on each of the vertices on the basis of the second coordinate data to connect the vertices together to form units such as lines, faces, or the like, which are the at least one first primitive corresponding to the three-dimensional mask model.

The geometry shader may be used to perform more detailed processing of the first primitive. For example, the geometry shader may be used to divide the first primitive to obtain the second primitives. In other words, the second primitives may be the output result of the geometry shader, which may be primitives obtained after the division of the first primitive. For example, the first primitive is input into the geometry shader, and primitives outputted by the geometry shader are used as the second primitives.

It should be noted that the geometry shader is an operation based on the first primitive, which has as input the first primitive (such as a triangle or a rectangle, or the like), and the geometry shader will add a different number of vertices depending on different shapes of the primitive, and has as output the second primitives. For example, vertices may be constructed based on the first primitive and a predefined maximum output number of vertices to generate more primitives, namely, the second primitives.

In an example, rasterization processing may be performed on each of the second primitives, and the fragments obtained after the processing are the fragments corresponding to the three-dimensional mask model. It should be noted that rasterization is a process of converting vertex data into fragments in the world spatial coordinate system, which has the function of converting an image into an image composed of individual rasters.

In an example, the third coordinate data of each of the fragments in the local spatial coordinate system is determined on the basis of the following approach: interpolating the first coordinate data based on the second coordinate data to obtain the third coordinate data of each of the fragments in the local spatial coordinate system.

As mentioned above, the second coordinate data is the coordinate of each of the vertices in the world spatial coordinate system, and the first coordinate data is the coordinate of each of the vertices in the local spatial coordinate system. For example, interpolation processing may be performed on the first coordinate data based on the second coordinate data in accordance with distribution information of each of the fragments (such as the number of fragments in each row or column, the positional relationship with adjacent vertices, or the like) to determine the third coordinate data of each of the fragments in the local spatial coordinate system.

S250: Shade the fragment on the basis of the third coordinate data in the fragment shader to obtain the region mask image corresponding to the region to be processed.

For example, through the fragment shader, shading processing may be performed on a fragment corresponding to each of the third coordinate data. In this embodiment of the present disclosure, the colors of the fragments may be determined based on the actual needs, which is not limited herein. The colors of different fragments may be the same or different.

In the embodiments of the present disclosure, shading the fragment on the basis of the third coordinate data may be shading the fragment on the basis of the third coordinate data and a preset color corresponding to the fragment, or shading the fragment on the basis of the third coordinate data and the region to be processed. The image obtained after the shading processing is used as the region mask image corresponding to the region to be processed.

S260: Apply the region mask image to the region to be processed for the screen image to be processed to obtain a target effect image, and display the target effect image.

In this embodiment of the present disclosure, by obtaining first coordinate data of each of the vertices of the three-dimensional mask model in a local spatial coordinate system, and inputting the first coordinate data into a vertex shader to convert the first coordinate data into second coordinate data in a world spatial coordinate system, conversion is performed on the vertices between the local spatial coordinate system and the world spatial coordinate system. Further, by determining fragments corresponding to the three-dimensional mask model on the basis of the second coordinate data, and determining third coordinate data of each of the fragments in the local spatial coordinate system, and inputting the third coordinate data into the fragment shader, the three-dimensional mask model may be divided more finely to enable the three-dimensional mask model to have better three-dimensionality. By shading the fragment on the basis of the third coordinate data in the fragment shader to obtain the region mask image corresponding to the region to be processed, a part of the image that has been subjected to effect processing is obtained, which avoids the situation of poor adaptability of the three-dimensional mask model to the region to be processed and the situation of insufficient three-dimensionality of the three-dimensional mask model, thus realizing the enhancement of the three-dimensionality of the three-dimensional mask model through coordinate conversion and primitive assembly, and improving the adaptability of the three-dimensional mask model to the region to be processed.

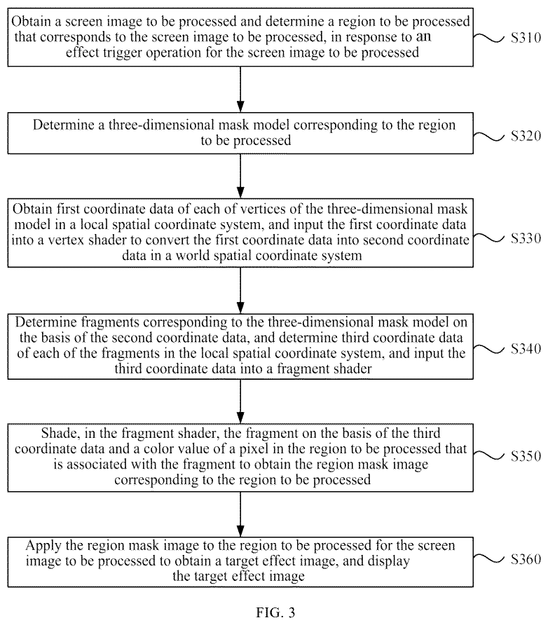

FIG. 3 is a schematic flowchart of another effect processing method according to an embodiment of the present disclosure. On the basis of the foregoing embodiments, reference may be made to the description of this embodiment for a method of shading the fragment on the basis of the third coordinate data. Explanations of the terms identical or corresponding to those in the above embodiments are not repeated herein.

As shown in FIG. 3, the method includes the following steps:

S310: Obtain a screen image to be processed and determine a region to be processed that corresponds to the screen image to be processed, in response to an effect trigger operation for the screen image to be processed.

S320: Determine a three-dimensional mask model corresponding to the region to be processed.

S330: Obtain first coordinate data of each of vertices of the three-dimensional mask model in a local spatial coordinate system, and input the first coordinate data into a vertex shader to convert the first coordinate data into second coordinate data in a world spatial coordinate system.

S340: Determine fragments corresponding to the three-dimensional mask model on the basis of the second coordinate data, and determine third coordinate data of each of the fragments in the local spatial coordinate system, and input the third coordinate data into a fragment shader.

S350: Shade, in the fragment shader, the fragment on the basis of the third coordinate data and a color value of a pixel in the region to be processed that is associated with the fragment to obtain the region mask image corresponding to the region to be processed.

For example, through the fragment shader, the third coordinate data may be converted into coordinate data corresponding to the region to be processed to determine a pixel in the region to be processed that is associated with each of the third coordinate data, and these pixels are pixels associated with each of the fragments. For each of the fragments, the color value required for shading the fragment may be determined based on the color value of the pixel associated with the fragment to shade the fragment, and the image obtained after the shading processing is used as the region mask image corresponding to the region to be processed.

S360: Apply the region mask image to the region to be processed for the screen image to be processed to obtain a target effect image, and display the target effect image.

In this embodiment of the present disclosure, by shading the fragment on the basis of the third coordinate data and a color value of a pixel in the region to be processed that is associated with the fragment, it is possible to avoid the situations in which the effect is overly planar, the shading effect is overly undiversified, and the difference from the image to be processed is too large, thereby realizing the shading of the associated fragment by the color value of the pixel in the region to be processed, thus improving the shading effect and three-dimensionality in the effect, and improving the adaptability of the color value of the effect to the screen image to be processed.

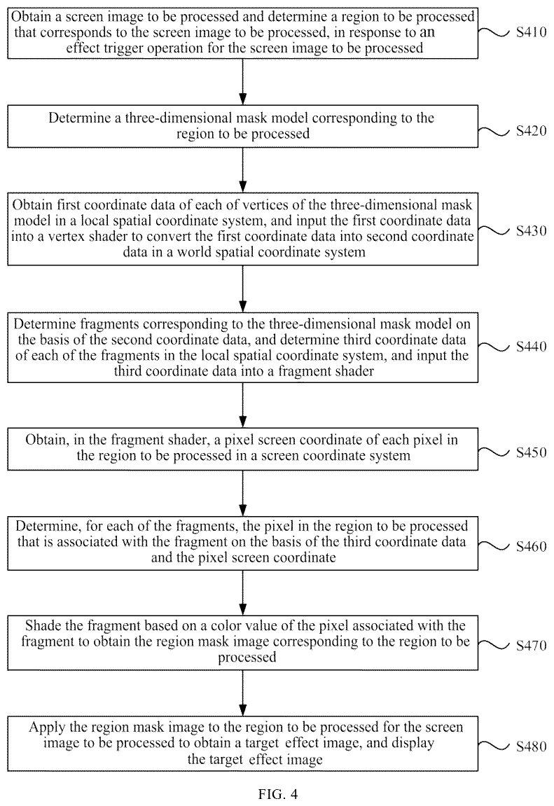

FIG. 4 is a schematic flowchart of another effect processing method according to an embodiment of the present disclosure. On the basis of the foregoing embodiments, reference may be made to the description of this embodiment for a method of shading the fragment on the basis of the third coordinate data and a color value of a pixel in the region to be processed that is associated with the fragment. Explanations of the terms identical or corresponding to those in the above embodiments are not repeated herein.

As shown in FIG. 4, the method includes the following steps:

S410: Obtain a screen image to be processed and determine a region to be processed that corresponds to the screen image to be processed, in response to an effect trigger operation for the screen image to be processed.

S420: Determine a three-dimensional mask model corresponding to the region to be processed.

S430: Obtain first coordinate data of each of vertices of the three-dimensional mask model in a local spatial coordinate system, and input the first coordinate data into a vertex shader to convert the first coordinate data into second coordinate data in a world spatial coordinate system.

S440: Determine fragments corresponding to the three-dimensional mask model on the basis of the second coordinate data, and determine third coordinate data of each of the fragments in the local spatial coordinate system, and input the third coordinate data into a fragment shader.

S450: Obtain, in the fragment shader, a pixel screen coordinate of each pixel in the region to be processed in a screen coordinate system.

The screen coordinate system may be a coordinate system required for subsequent display of the image to be processed. The pixel screen coordinate may be a coordinate of each of the pixels in the region to be processed in the screen coordinate system.

For example, in the fragment shader, a coordinate corresponding to each of the pixels in the region to be processed may be determined in the screen coordinate system, which is the pixel screen coordinate.

S460: Determine, for each of the fragments, the pixel in the region to be processed that is associated with the fragment on the basis of the third coordinate data and the pixel screen coordinate.

For example, the third coordinate data may be converted from the local spatial coordinate system into the screen coordinate system, and matching may be performed with the pixel screen coordinate based on the converted third coordinate data to determine pixels corresponding to the fragment corresponding to the third coordinate data, and these pixels may be used as pixels in the region to be processed that are associated with the fragment.

In an example, the pixel in the region to be processed that is associated with the fragment may be determined on the basis of the third coordinate data and the pixel screen coordinate in the following approach, so as to accurately determine the association relationship between the fragment and the pixels in the region to be processed:

converting the third coordinate data into a fourth coordinate matrix in the world spatial coordinate system, and performing a perspective division operation on the fourth coordinate matrix to obtain a fragment screen coordinate of the fragment in the screen coordinate system; and determining the pixel in the region to be processed that is associated with the fragment based on the fragment screen coordinate and the pixel screen coordinate.

The fourth coordinate matrix may be a coordinate matrix obtained by converting the third coordinate data into the world spatial coordinate system. The perspective division operation may be an operation for converting a coordinate from the world spatial coordinate system to the screen coordinate system.

For example, the third coordinate data is converted from the local spatial coordinate system to the world spatial coordinate system to obtain the fourth coordinate matrix. Further, a perspective division operation is performed on the fourth coordinate matrix to convert the fourth coordinate matrix into the screen coordinate system to obtain the fragment screen coordinate, which may be understood as the fragment screen coordinate of the fragment corresponding to the third coordinate data in the screen coordinate system.

In an example, matching may be performed between fragment screen coordinates and pixel screen coordinates to determine a pixel screen coordinate matching the fragment screen coordinate. Further, an association is established between a pixel in the region to be processed that corresponds to the matched pixel screen coordinate and the fragment corresponding to the fragment screen coordinate.

In an example, the third coordinate data may be converted into the fourth coordinate matrix in the world spatial coordinate system in the following approach, so as to accurately and quickly perform coordinate conversion between the local spatial coordinate system and the world spatial coordinate system: determining a model matrix, a view matrix, and a projection matrix of the three-dimensional mask model based on a positional matching relationship between the three-dimensional mask model and the region to be processed; and converting the third coordinate data into the fourth coordinate matrix in the world spatial coordinate system based on the model matrix, the view matrix, and the projection matrix.

The positional matching relationship is determined based on a model key point of the three-dimensional mask model and a region key point of the region to be processed.

For example, the model key point of the three-dimensional mask model and the region key point of the region to be processed are first determined, and an association is established between the model key point and the region key point to obtain the positional matching relationship between the three-dimensional mask model and the region to be processed. Based on the positional matching relationship, the model view projection (MVP) matrices, namely a model matrix, a view matrix, and a projection matrix, required for conversion from the local spatial coordinate system to the world spatial coordinate system can be calculated.

In an example, the third coordinate data may be converted into the world spatial coordinate system by multiplying the third coordinate data by the model matrix, the view matrix, and the projection matrix, so as to obtain the fourth coordinate matrix.

In an example, the pixel in the region to be processed that is associated with the fragment may be determined based on the fragment screen coordinate and the pixel screen coordinate in the following approach, so as to more accurately and meticulously determine the pixel associated with the fragment:
dividing the region to be processed into at least one sub-region; determining, for each of the fragments, a sub-region associated with the fragment based on the fragment screen coordinate and a pixel screen coordinate of a pixel in each sub-region; and determining the pixel in the region to be processed that is associated with the fragment based on a pixel in the sub-region associated with the fragment.

For example, the region to be processed may be divided based on a preset number of sub-regions or a preset sub-region shape, or the like to obtain at least one sub-region corresponding to the region to be processed. For each of the fragments, a sub-region associated with the fragment may be determined using the same approach, as illustrated using one of fragments as an example. Matching with the pixel screen coordinate of the pixel in each sub-region is performed based on the fragment screen coordinate, and a successfully matched sub-region is used as the sub-region associated with the fragment. The approach for performing the matching may be a distance matching approach, or the like, which is not limited in this embodiment. The pixel in the sub-region associated with the fragment is used as the pixel in the region to be processed that is associated with the fragment.

It should be noted that there may be one or more pixels in each sub-region. There may be one or more pixels associated with a fragment.

In an example, the pixel in the region to be processed that is associated with the fragment may be determined based on the pixel in the sub-region associated with the fragment in any one of the following approaches:

Approach 1: Use a pixel located at a preset position of the sub-region associated with the fragment as the pixel in the region to be processed that is associated with the fragment.

The number of preset positions may be one or more. For example, it may be a position at a center point of the sub-region, or a position at an edge point of the sub-region, or a vertex position of the sub-region, or a position randomly obtained from the sub-region, or the like. It can be understood that in this embodiment of the present disclosure, the preset position may be set based on the actual needs, and the coordinate or selection method thereof, or the like are not limited.

In an example, a pixel located at a center position of the sub-region associated with the fragment is used as the pixel in the region to be processed that is associated with the fragment.

Approach 2: Use each pixel in the sub-region associated with the fragment as the pixel in the region to be processed that is associated with the fragment.

S470: Shade the fragment based on a color value of the pixel associated with the fragment to obtain the region mask image corresponding to the region to be processed.

For example, after at least one pixel associated with the fragment is determined, color values of these pixels may be processed to obtain a color value to be used in subsequent shading. Further, the fragment is shaded based on the color value to be used in the subsequent shading, and an image composed of shaded fragments is used as the region mask image corresponding to the region to be processed.

In an example, the fragment may be shaded in different approaches, which may be: selecting a color value of one pixel associated with the fragment as a color value of the fragment to shade the fragment.

For example, a color value of one pixel associated with the fragment is selected as the color value of the fragment, and the fragment is shaded based on the color value of the fragment. If there is only one pixel associated with the fragment, the color value of this pixel may be used as the color value of the fragment; and if there are at least two pixels associated with the fragment, one of the pixels may be selected based on the position, or one of the pixels may be selected based on the color value, or one of the pixels may be selected in other approaches, and the color value of the pixel is used as the color value of the fragment, where the selection based on the position may be selecting a pixel at the center, selecting a pixel at an upper left vertex, or the like, and the specific position may be set based on the needs, and the selection based on the color value may be selecting a pixel with the largest color value, a pixel with the smallest color value, or the like, and the specific approach may be set based on the needs.

In the case where there are two or more pixels associated with the fragment, an average value of color values of the two or more pixels associated with the fragment is calculated, and the average value is used as the color value of the fragment to shade the fragment.

For example, two or more pixels may be selected from the pixels associated with the fragment. It may be selecting all of the pixels, or selecting some of the pixels. For example, selecting some of the pixels may be selecting pixels located at four vertices. After the two or more pixels associated with the fragment are determined, an average value of color values of these pixels is calculated, and this average value is used as the color value of the fragment, and the fragment is shaded based on the color value of the fragment.

S480: Apply the region mask image to the region to be processed for the screen image to be processed to obtain a target effect image, and display the target effect image.

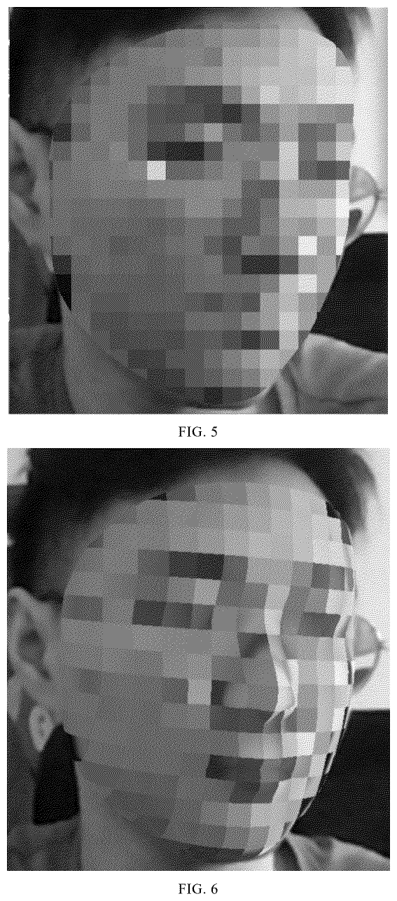

For example, FIG. 5 is a schematic diagram of an effect image obtained by processing using a related technology, and FIG. 6 is a schematic diagram of a target effect image obtained by processing on the basis of an effect processing method of an embodiment of the present disclosure. It can be seen from FIG. 5 and FIG. 6 that the target effect image obtained by the embodiments of the present disclosure can improve the three-dimensionality of the effect image and enrich the image display effect compared with the effect image obtained by processing using the related technology.

In this embodiment of the present disclosure, by obtaining a pixel screen coordinate of each pixel in the region to be processed in the screen coordinate system, determining, for each of the fragments, a pixel in the region to be processed that is associated with the fragment on the basis of the third coordinate data and the pixel screen coordinate, and shading the fragment based on a color value of the pixel associated with the fragment, it is possible to avoid the difficulty in associating the fragment with pixels in the region to be processed and thus realize the improvement of the accuracy in determining the color value of the fragment, which in turn improves the three-dimensionality of the effect of the effect.

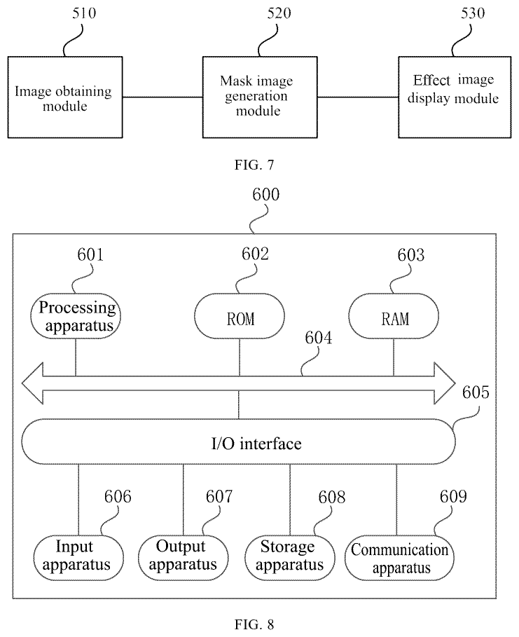

FIG. 7 is a schematic diagram of a structure of an effect processing apparatus according to an embodiment of the present disclosure. As shown in FIG. 7, the apparatus includes: an image obtaining module 510, a mask image generation module 520, and an effect image display module 530.

The image obtaining module 510 is configured to obtain a screen image to be processed and determine a region to be processed that corresponds to the screen image to be processed, in response to an effect trigger operation for the screen image to be processed. The mask image generation module 520 is configured to determine a three-dimensional mask model corresponding to the region to be processed, and generate a region mask image corresponding to the region to be processed based on the three-dimensional mask model. The effect image display module 530 is configured to apply the region mask image to the region to be processed for the screen image to be processed to obtain a target effect image, and display the target effect image.

In an embodiment, the mask image generation module 520 is further configured to obtain first coordinate data of each of vertices of the three-dimensional mask model in a local spatial coordinate system, and input the first coordinate data into a vertex shader to convert the first coordinate data into second coordinate data in a world spatial coordinate system; determine fragments corresponding to the three-dimensional mask model on the basis of the second coordinate data, and determine third coordinate data of each of the fragments in the local spatial coordinate system, and input the third coordinate data into a fragment shader; and shade the fragment on the basis of the third coordinate data in the fragment shader to obtain the region mask image corresponding to the region to be processed.

In an embodiment, the mask image generation module 520 is further configured to shade the fragment on the basis of the third coordinate data and a color value of a pixel in the region to be processed that is associated with the fragment.

In an embodiment, the mask image generation module 520 is further configured to obtain a pixel screen coordinate of each pixel in the region to be processed in a screen coordinate system; determine, for each of the fragments, the pixel in the region to be processed that is associated with the fragment on the basis of the third coordinate data and the pixel screen coordinate; and shade the fragment based on the color value of the pixel associated with the fragment.

In an embodiment, the mask image generation module 520 is further configured to convert the third coordinate data into a fourth coordinate matrix in the world spatial coordinate system, and perform a perspective division operation on the fourth coordinate matrix to obtain a fragment screen coordinate of the fragment in the screen coordinate system; and determine the pixel in the region to be processed that is associated with the fragment based on the fragment screen coordinate and the pixel screen coordinate.

In an embodiment, the mask image generation module 520 is further configured to determine a model matrix, a view matrix, and a projection matrix of the three-dimensional mask model based on a positional matching relationship between the three-dimensional mask model and the region to be processed, where the positional matching relationship is determined based on a model key point of the three-dimensional mask model and a region key point of the region to be processed; and convert the third coordinate data into the fourth coordinate matrix in the world spatial coordinate system based on the model matrix, the view matrix, and the projection matrix.

In an embodiment, the mask image generation module 520 is further configured to divide the region to be processed into at least one sub-region; determine, for each of the fragments, a sub-region associated with the fragment based on the fragment screen coordinate and a pixel screen coordinate of a pixel in each sub-region; and determine the pixel in the region to be processed that is associated with the fragment based on a pixel in the sub-region associated with the fragment.

In an embodiment, the mask image generation module 520 is further configured to use a pixel located at a center position of the sub-region associated with the fragment as the pixel in the region to be processed that is associated with the fragment; or use each pixel in the sub-region associated with the fragment as the pixel in the region to be processed that is associated with the fragment.

In an embodiment, the mask image generation module 520 is further configured to select a color value of one pixel associated with the fragment as a color value of the fragment to shade the fragment; or calculate an average value of color values of two or more pixels associated with the fragment, and use the average value as a color value of the fragment to shade the fragment.

In an embodiment, the mask image generation module 520 is further configured to perform primitive assembly on each of the vertices on the basis of the second coordinate data to obtain at least one first primitive corresponding to the three-dimensional mask model; process the first primitive by a geometry shader to divide the first primitive into at least two second primitives; and perform rasterization processing on each of the second primitives to obtain the fragments corresponding to the three-dimensional mask model.

In an embodiment, the mask image generation module 520 is further configured to interpolate the first coordinate data based on the second coordinate data to obtain the third coordinate data of each of the fragments in the local spatial coordinate system.

In an embodiment, the mask image generation module 520 is further configured to construct the three-dimensional mask model corresponding to the region to be processed based on image information contained in the region to be processed; or determine a three-dimensional mask model matching the region to be processed from a pre-established three-dimensional mask model library based on image information contained in the region to be processed, where the three-dimensional mask model library includes at least one three-dimensional mask model.

In this embodiment of the present disclosure, by obtaining a screen image to be processed and determining a region to be processed that corresponds to the screen image to be processed, in response to an effect trigger operation for the screen image to be processed, a part of the screen image to be processed that is to be subjected to effect processing is determined, which supports effect processing of a part or all of the screen image to be processed. Further, by determining a three-dimensional mask model corresponding to the region to be processed, and generating a region mask image corresponding to the region to be processed based on the three-dimensional mask model, a region mask image with three-dimensionality is obtained, and by applying the region mask image to the region to be processed for the screen image to be processed to obtain a target effect image, and displaying the target effect image, it is possible to avoid the situations of a poor effect of the effect due to the effect being overly planar and of poor adaptability between the effect and the image, thereby enabling the processed region to be processed to have three-dimensionality and the target effect image to be more vivid, thus enriching the display effect of the image.

The effect processing apparatus according to an embodiment of the present disclosure can perform the effect processing method according to any one of the embodiments of the present disclosure, and has corresponding functional modules and beneficial effects for performing the method.

It is worth noting that the units and modules included in the above apparatus are obtained through division merely according to functional logic, but are not limited to the above division, as long as corresponding functions can be implemented. In addition, names of the functional units are merely used for mutual distinguishing, and are not used to limit the protection scope of the embodiments of the present disclosure.

FIG. 8 is a schematic diagram of a structure of an electronic device according to an embodiment of the present disclosure. Reference is made to FIG. 8 below, which is a schematic diagram of a structure of an electronic device (such as a terminal device or a server in FIG. 8) 600 suitable for implementing embodiments of the present disclosure. The terminal device in this embodiment of the present disclosure may include, but is not limited to, mobile terminals such as a mobile phone, a notebook computer, a digital broadcast receiver, a personal digital assistant (PDA), a tablet computer (PAD), a portable multimedia player (PMP), and a vehicle-mounted terminal (such as a vehicle navigation terminal), and fixed terminals such as a digital television (TV) and a desktop computer. The electronic device shown in FIG. 8 is merely an example, and shall not impose any limitation on the function and scope of use of the embodiments of the present disclosure.

As shown in FIG. 8, the electronic device 600 may include a processing apparatus (e.g., a central processing unit, a graphics processing unit, etc.) 601 that may perform a variety of appropriate actions and processing in accordance with a program stored in a read-only memory (ROM) 602 or a program loaded from a storage apparatus 608 into a random access memory (RAM) 603. The RAM 603 further stores various programs and data required for the operation of the electronic device 600. The processing apparatus 601, the ROM 602, and the RAM 603 are connected to each other through a bus 604. An input/output (I/O) interface 605 is also connected to the bus 604.

Generally, the following apparatuses may be connected to the I/O interface 605: an input apparatus 606 including, for example, a touchscreen, a touchpad, a keyboard, a mouse, a camera, a microphone, an accelerometer, and a gyroscope; an output apparatus 607 including, for example, a liquid crystal display (LCD), a speaker, and a vibrator; the storage apparatus 608 including, for example, a tape and a hard disk; and a communication apparatus 609. The communication apparatus 609 may allow the electronic device 600 to perform wireless or wired communication with other devices to exchange data. Although FIG. 8 shows the electronic device 600 having various apparatuses, it should be understood that it is not required to implement or have all of the shown apparatuses. It may be an alternative to implement or have more or fewer apparatuses.

In particular, according to an embodiment of the present disclosure, the process described above with reference to the flowchart may be implemented as a computer software program. For example, this embodiment of the present disclosure includes a computer program product, which includes a computer program carried on a non-transitory computer-readable medium, where the computer program includes program code for performing the method shown in the flowchart. In such an embodiment, the computer program may be downloaded and installed from a network through the communication apparatus 609, installed from the storage apparatus 608, or installed from the ROM 602. When the computer program is executed by the processing apparatus 601, the above-mentioned functions defined in the method of the embodiment of the present disclosure are performed.

The names of messages or information exchanged between a plurality of apparatuses in the implementations of the present disclosure are used for illustrative purposes only, and are not used to limit the scope of these messages or information.

The electronic device according to an embodiment of the present disclosure and the effect processing method according to the above embodiments belong to the same inventive concept. For the technical details not exhaustively described in this embodiment, reference may be made to the above embodiments, and this embodiment and the above embodiments have the same beneficial effects.

An embodiment of the present disclosure provides a computer storage medium storing a computer program thereon, where the program, when executed by a processor, implements the effect processing method according to the above embodiments.

It should be noted that the above computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. Examples of the computer-readable storage medium may include, but are not limited to: an electrical connection having one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may also be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

In some implementations, a client and a server may communicate using any currently known or future-developed network protocol such as the HyperText Transfer Protocol (HTTP), and may be connected to digital data communication (for example, a communication network) in any form or medium. Examples of the communication network include a local area network (LAN), a wide area network (WAN), an internetwork (for example, the Internet), a peer-to-peer network (for example, an ad hoc peer-to-peer network), and any currently known or future-developed network.

The above computer-readable medium may be contained in the above electronic device. Alternatively, the computer-readable medium may exist independently, without being assembled into the electronic device.

The above computer-readable medium carries one or more programs that, when executed by the electronic device, cause the electronic device to:
obtain a screen image to be processed and determine a region to be processed that corresponds to the screen image to be processed, in response to an effect trigger operation for the screen image to be processed;
determine a three-dimensional mask model corresponding to the region to be processed, and generate a region mask image corresponding to the region to be processed based on the three-dimensional mask model; and
apply the region mask image to the region to be processed for the screen image to be processed to obtain a target effect image, and display the target effect image.

The storage medium may be a non-transitory storage medium.

Computer program code for performing operations of the present disclosure can be written in one or more programming languages or a combination thereof, where the programming languages include but are not limited to object-oriented programming languages, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the circumstance involving a remote computer, the remote computer may be connected to a computer of a user over any type of network, including a local area network (LAN) or a wide area network (WAN), or may be connected to an external computer (for example, connected over the Internet using an Internet service provider).

The flowchart and block diagram in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by software, or may be implemented by hardware. Names of the units do not constitute a limitation on the units themselves in some cases, for example, a first obtaining unit may alternatively be described as “a unit for obtaining at least two Internet Protocol addresses”.

The functions described herein above may be performed at least partially by one or more hardware logic components. For example, without limitation, exemplary types of hardware logic components that may be used include: a field-programmable gate array (FPGA), an application-specific integrated circuit (ASIC), application-specific standard product (ASSP), a system-on-chip (SOC) system, a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. Examples of the machine-readable storage medium may include an electrical connection based on one or more wires, a portable computer disk, a hard disk, a random access memory (RAM), a read-only memory (ROM), an erasable programmable read-only memory (EPROM) or a flash memory, an optic fiber, a portable compact disk read-only memory (CD-ROM), an optical storage device, a magnetic storage device, or any suitable combination thereof.

According to one or more embodiments of the present disclosure, [Example 1] provides an effect processing method, the method including:
obtaining a screen image to be processed and determining a region to be processed that corresponds to the screen image to be processed, in response to an effect trigger operation for the screen image to be processed;
determining a three-dimensional mask model corresponding to the region to be processed, and generating a region mask image corresponding to the region to be processed based on the three-dimensional mask model; and
applying the region mask image to the region to be processed for the screen image to be processed to obtain a target effect image, and displaying the target effect image.

According to one or more embodiments of the present disclosure, [Example 2] provides an effect processing method, further including:
the generating a region mask image corresponding to the region to be processed based on the three-dimensional mask model includes:
obtaining first coordinate data of each of vertices of the three-dimensional mask model in a local spatial coordinate system, and inputting the first coordinate data into a vertex shader to convert the first coordinate data into second coordinate data in a world spatial coordinate system;
determining fragments corresponding to the three-dimensional mask model on the basis of the second coordinate data, and determining third coordinate data of each of the fragments in the local spatial coordinate system, and inputting the third coordinate data into a fragment shader; and
shading the fragment on the basis of the third coordinate data in the fragment shader to obtain the region mask image corresponding to the region to be processed.

According to one or more embodiments of the present disclosure, [Example 3] provides an effect processing method, further including:
the shading the fragment on the basis of the third coordinate data includes:
shading the fragment on the basis of the third coordinate data and a color value of a pixel in the region to be processed that is associated with the fragment.

According to one or more embodiments of the present disclosure, [Example 4] provides an effect processing method, further including:
the shading the fragment on the basis of the third coordinate data and a color value of a pixel in the region to be processed that is associated with the fragment includes:
obtaining a pixel screen coordinate of each pixel in the region to be processed in a screen coordinate system;
determining, for each of the fragments, the pixel in the region to be processed that is associated with the fragment on the basis of the third coordinate data and the pixel screen coordinate; and
shading the fragment based on the color value of the pixel associated with the fragment.

According to one or more embodiments of the present disclosure, [Example 5] provides an effect processing method, further including:
the determining the pixel in the region to be processed that is associated with the fragment on the basis of the third coordinate data and the pixel screen coordinate includes:
converting the third coordinate data into a fourth coordinate matrix in the world spatial coordinate system, and performing a perspective division operation on the fourth coordinate matrix to obtain a fragment screen coordinate of the fragment in the screen coordinate system; and
determining the pixel in the region to be processed that is associated with the fragment based on the fragment screen coordinate and the pixel screen coordinate.

According to one or more embodiments of the present disclosure, [Example 6] provides an effect processing method, further including:
the converting the third coordinate data into a fourth coordinate matrix in the world spatial coordinate system includes:
determining a model matrix, a view matrix, and a projection matrix of the three-dimensional mask model based on a positional matching relationship between the three-dimensional mask model and the region to be processed, wherein the positional matching relationship is determined based on a model key point of the three-dimensional mask model and a region key point of the region to be processed; and
converting the third coordinate data into the fourth coordinate matrix in the world spatial coordinate system based on the model matrix, the view matrix, and the projection matrix.

According to one or more embodiments of the present disclosure, [Example 7] provides an effect processing method, further including:
the determining the pixel in the region to be processed that is associated with the fragment based on the fragment screen coordinate and the pixel screen coordinate includes:
dividing the region to be processed into at least one sub-region;
determining, for each of the fragments, a sub-region associated with the fragment based on the fragment screen coordinate and a pixel screen coordinate of a pixel in each sub-region; and
determining the pixel in the region to be processed that is associated with the fragment based on a pixel in the sub-region associated with the fragment.

According to one or more embodiments of the present disclosure, [Example 8] provides an effect processing method, further including:
the determining the pixel in the region to be processed that is associated with the fragment based on a pixel in the sub-region associated with the fragment includes:
using a pixel located at a center position of the sub-region associated with the fragment as the pixel in the region to be processed that is associated with the fragment; or
using each pixel in the sub-region associated with the fragment as the pixel in the region to be processed that is associated with the fragment.

According to one or more embodiments of the present disclosure, [Example 9] provides an effect processing method, further including:
the shading the fragment based on the color value of the pixel associated with the fragment includes: selecting a color value of one pixel associated with the fragment as a color value of the fragment to shade the fragment; or
calculating an average value of color values of two or more pixels associated with the fragment, and using the average value as a color value of the fragment to shade the fragment.

According to one or more embodiments of the present disclosure, [Example 10] provides an effect processing method, further including:
the determining fragments corresponding to the three-dimensional mask model on the basis of the second coordinate data includes:
performing primitive assembly on each of vertices on the basis of the second coordinate data to obtain at least one first primitive corresponding to the three-dimensional mask model;
processing the first primitive by a geometry shader to divide the first primitive into at least two second primitives; and
performing rasterization processing on each of the second primitives to obtain the fragments corresponding to the three-dimensional mask model.

According to one or more embodiments of the present disclosure, [Example 11] provides an effect processing method, further including:
the determining third coordinate data of each of the fragments in the local spatial coordinate system includes:
interpolating the first coordinate data based on the second coordinate data to obtain the third coordinate data of each of the fragments in the local spatial coordinate system.

According to one or more embodiments of the present disclosure, [Example 12] provides an effect processing method, further including:
the determining a three-dimensional mask model corresponding to the region to be processed includes:
constructing the three-dimensional mask model corresponding to the region to be processed based on image information contained in the region to be processed; or
determining a three-dimensional mask model matching the region to be processed from a pre-established three-dimensional mask model library based on image information contained in the region to be processed, wherein the three-dimensional mask model library comprises at least one three-dimensional mask model.

According to one or more embodiments of the present disclosure, [Example 13] provides an effect processing apparatus, the apparatus including:
an image obtaining module configured to obtain a screen image to be processed and determine a region to be processed that corresponds to the screen image to be processed, in response to an effect trigger operation for the screen image to be processed;
a mask image generation module configured to determine a three-dimensional mask model corresponding to the region to be processed, and generate a region mask image corresponding to the region to be processed based on the three-dimensional mask model; and
an effect image display module configured to apply the region mask image to the region to be processed for the screen image to be processed to obtain a target effect image, and display the target effect image.

It should be understood by a person skilled in the art that the scope of disclosure involved in the present disclosure is not limited to the embodiments formed by specific combinations of the above-mentioned technical features, but should also cover other embodiments formed by any combination of the above-mentioned technical features or their equivalent features without departing from the above-mentioned disclosure concept, for example, embodiments formed by interchanging the above-mentioned features with technical features having similar functions disclosed in the present disclosure (but not limited thereto).

In addition, although the various operations are depicted in a specific order, it should not be construed as requiring these operations to be performed in the specific order shown or in a sequential order. Under certain circumstances, multitasking and parallel processing may be advantageous. Similarly, although several implementation details are included in the foregoing discussions, these details should not be construed as limiting the scope of the present disclosure. Some features that are described in the context of separate embodiments can also be implemented in combination in a single embodiment. In contrast, various features described in the context of a single embodiment may alternatively be implemented in a plurality of embodiments individually or in any suitable subcombination.

Although the subject matter has been described in a language specific to structural features and/or logical actions of the method, it should be understood that the subject matter defined in the appended claims is not necessarily limited to the specific features or actions described above. In contrast, the specific features and actions described above are merely exemplary forms of implementing the claims.

1. An effect processing method, comprising:
obtaining a screen image to be processed and determining a region to be processed that corresponds to the screen image to be processed, in response to an effect trigger operation for the screen image to be processed;
determining a three-dimensional mask model corresponding to the region to be processed, and generating a region mask image corresponding to the region to be processed based on the three-dimensional mask model; and
applying the region mask image to the region to be processed for the screen image to be processed to obtain a target effect image, and displaying the target effect image.

2. The effect processing method according to claim 1, wherein the generating a region mask image corresponding to the region to be processed based on the three-dimensional mask model comprises:
obtaining first coordinate data of at least one vertex of the three-dimensional mask model in a local spatial coordinate system, and inputting the first coordinate data into a vertex shader to convert the first coordinate data into second coordinate data in a world spatial coordinate system;
determining fragments corresponding to the three-dimensional mask model on the basis of the second coordinate data, and determining third coordinate data of each of the fragments in the local spatial coordinate system, and inputting the third coordinate data into a fragment shader; and
shading the fragment on the basis of the third coordinate data in the fragment shader to obtain the region mask image corresponding to the region to be processed.

3. The effect processing method according to claim 2, wherein the shading the fragment on the basis of the third coordinate data comprises:
shading the fragment on the basis of the third coordinate data and a color value of a pixel in the region to be processed that is associated with the fragment.

4. The effect processing method according to claim 3, wherein the shading the fragment on the basis of the third coordinate data and a color value of a pixel in the region to be processed that is associated with the fragment comprises:
obtaining a pixel screen coordinate of each pixel in the region to be processed in a screen coordinate system;
determining, for each of the fragments, the pixel in the region to be processed that is associated with the fragment on the basis of the third coordinate data and the pixel screen coordinate; and
shading the fragment based on the color value of the pixel associated with the fragment.

5. The effect processing method according to claim 4, wherein the determining the pixel in the region to be processed that is associated with the fragment on the basis of the third coordinate data and the pixel screen coordinate comprises:
converting the third coordinate data into a fourth coordinate matrix in the world spatial coordinate system, and performing a perspective division operation on the fourth coordinate matrix to obtain a fragment screen coordinate of the fragment in the screen coordinate system; and
determining the pixel in the region to be processed that is associated with the fragment based on the fragment screen coordinate and the pixel screen coordinate.

6. The effect processing method according to claim 5, wherein the converting the third coordinate data into a fourth coordinate matrix in the world spatial coordinate system comprises:
determining a model matrix, a view matrix, and a projection matrix of the three-dimensional mask model based on a positional matching relationship between the three-dimensional mask model and the region to be processed, wherein the positional matching relationship is determined based on a model key point of the three-dimensional mask model and a region key point of the region to be processed; and
converting the third coordinate data into the fourth coordinate matrix in the world spatial coordinate system based on the model matrix, the view matrix, and the projection matrix.

7. The effect processing method according to claim 5, wherein the determining the pixel in the region to be processed that is associated with the fragment based on the fragment screen coordinate and the pixel screen coordinate comprises:
dividing the region to be processed into at least one sub-region;
determining, for each of the fragments, a sub-region associated with the fragment based on a fragment screen coordinate of each of the fragments and a pixel screen coordinate of a pixel in each sub-region; and
determining the pixel in the region to be processed that is associated with the fragment based on a pixel in the sub-region associated with the fragment.

8. The effect processing method according to claim 7, wherein the determining the pixel in the region to be processed that is associated with the fragment based on a pixel in the sub-region associated with the fragment comprises:
using a pixel located at a center position of the sub-region associated with the fragment as the pixel in the region to be processed that is associated with the fragment; or
using each pixel in the sub-region associated with the fragment as the pixel in the region to be processed that is associated with the fragment.

9. The effect processing method according to claim 4, wherein the shading the fragment based on the color value of the pixel associated with the fragment comprises:
selecting a color value of one pixel associated with the fragment as a color value of the fragment to shade the fragment; or
calculating an average value of color values of two or more pixels associated with the fragment, and using the average value as a color value of the fragment to shade the fragment.

10. The effect processing method according to claim 2, wherein the determining fragments corresponding to the three-dimensional mask model on the basis of the second coordinate data comprises:
performing primitive assembly on the at least one vertex on the basis of the second coordinate data to obtain at least one first primitive corresponding to the three-dimensional mask model;
processing each first primitive by a geometry shader to divide the first primitive into at least two second primitives; and
performing rasterization processing on each of the second primitives to obtain the fragments corresponding to the three-dimensional mask model.

11. The effect processing method according to claim 2, wherein the determining third coordinate data of each of the fragments in the local spatial coordinate system comprises:
interpolating the first coordinate data based on the second coordinate data to obtain the third coordinate data of each of the fragments in the local spatial coordinate system.

12. The effect processing method according to claim 1, wherein the determining a three-dimensional mask model corresponding to the region to be processed comprises:
constructing the three-dimensional mask model corresponding to the region to be processed based on image information contained in the region to be processed; or
determining a three-dimensional mask model matching the region to be processed from a pre-established three-dimensional mask model library based on image information contained in the region to be processed, wherein the three-dimensional mask model library comprises at least one three-dimensional mask model.

13. (canceled)

14. An electronic device, comprising:
one or more processors; and
a memory configured to store one or more programs, wherein the one or more programs, when executed by the one or more processors, cause the one or more processors to:
obtain a screen image to be processed and determining a region to be processed that corresponds to the screen image to be processed, in response to an effect trigger operation for the screen image to be processed;
determine a three-dimensional mask model corresponding to the region to be processed, and generate a region mask image corresponding to the region to be processed based on the three-dimensional mask model; and
apply the region mask image to the region to be processed for the screen image to be processed to obtain a target effect image, and display the target effect image.

15. A computer program product storing computer-executable instructions, wherein the computer-executable instructions, when executed by a processor, cause the processor to:
obtain a screen image to be processed and determining a region to be processed that corresponds to the screen image to be processed, in response to an effect trigger operation for the screen image to be processed;
determine a three-dimensional mask model corresponding to the region to be processed, and generate a region mask image corresponding to the region to be processed based on the three-dimensional mask model; and
apply the region mask image to the region to be processed for the screen image to be processed to obtain a target effect image, and display the target effect image.

16. The electronic device according to claim 14, wherein the instructions to generate the region mask image corresponding to the region to be processed based on the three-dimensional mask model comprise instructions to:
obtain first coordinate data of at least one vertex of the three-dimensional mask model in a local spatial coordinate system, and input the first coordinate data into a vertex shader to convert the first coordinate data into second coordinate data in a world spatial coordinate system;
determine fragments corresponding to the three-dimensional mask model on the basis of the second coordinate data, and determine third coordinate data of each of the fragments in the local spatial coordinate system, and input the third coordinate data into a fragment shader; and
shade the fragment on the basis of the third coordinate data in the fragment shader to obtain the region mask image corresponding to the region to be processed.

17. The electronic device according to claim 16, wherein the instructions to shade the fragment on the basis of the third coordinate data comprise instructions to:
shade the fragment on the basis of the third coordinate data and a color value of a pixel in the region to be processed that is associated with the fragment.

18. The electronic device according to claim 17, wherein the instructions to shade the fragment on the basis of the third coordinate data and a color value of a pixel in the region to be processed that is associated with the fragment comprise instructions to:
obtain a pixel screen coordinate of each pixel in the region to be processed in a screen coordinate system;
determine, for each of the fragments, the pixel in the region to be processed that is associated with the fragment on the basis of the third coordinate data and the pixel screen coordinate; and
shade the fragment based on the color value of the pixel associated with the fragment.

19. The electronic device according to claim 18, wherein the instructions to determine the pixel in the region to be processed that is associated with the fragment on the basis of the third coordinate data and the pixel screen coordinate comprise instructions to:
convert the third coordinate data into a fourth coordinate matrix in the world spatial coordinate system, and perform a perspective division operation on the fourth coordinate matrix to obtain a fragment screen coordinate of the fragment in the screen coordinate system; and
determine the pixel in the region to be processed that is associated with the fragment based on the fragment screen coordinate and the pixel screen coordinate.

20. The electronic device according to claim 19, wherein the instructions to convert the third coordinate data into a fourth coordinate matrix in the world spatial coordinate system comprise instructions to:
determine a model matrix, a view matrix, and a projection matrix of the three-dimensional mask model based on a positional matching relationship between the three-dimensional mask model and the region to be processed, wherein the positional matching relationship is determined based on a model key point of the three-dimensional mask model and a region key point of the region to be processed; and
convert the third coordinate data into the fourth coordinate matrix in the world spatial coordinate system based on the model matrix, the view matrix, and the projection matrix.

21. The electronic device according to claim 19, wherein the instructions to determine the pixel in the region to be processed that is associated with the fragment based on the fragment screen coordinate and the pixel screen coordinate comprise instructions to:
divide the region to be processed into at least one sub-region;
determine, for each of the fragments, a sub-region associated with the fragment based on a fragment screen coordinate of each of the fragments and a pixel screen coordinate of a pixel in each sub-region; and
determine the pixel in the region to be processed that is associated with the fragment based on a pixel in the sub-region associated with the fragment.
